(19) United States
(12) Patent Application Publication
(10) Pub. No.: US 2014/0025593 A1
(43) Pub. Date: Jan. 23, 2014

(54) Compliance Analysis System

(71) Applicant: DLC Enterprises, Inc., Knoxville, TN (US)

(72) Inventors: Brian E. Dolin, Knoxville, TN (US); Lee T. Fortier, Old Hickory, TN (US)

(73) Assignee: DLC Enterprises, Inc., Knoxville, TN (US)

(21) Appl. No.: 13/948,609

(22) Filed: Jul. 23, 2013

Related U.S. Application Data
(60) Provisional application No. 61/674,835, filed on Jul. 23, 2012.

(51) Int. Cl. G06Q 30/00

(52) U.S. Cl. CPC G06Q 30/018
USPC 705/317

(57) ABSTRACT

A compliance analysis system. The compliance analysis system is used to evaluate and monitor compliance with a collection of rules applicable to an entity or site. The compliance analysis system uses checklists to insure consistent inspections. The compliance analysis system provides comprehensive documentation of the inspection including reference materials based on the findings of the inspection. The compliance analysis system stores the results of each inspection and allows comparison of the inspection results over time and across sites. Reports and analysis by the compliance analysis system optionally estimate discretionary penalties for violations. User created additions and modifications to the compliance analysis system data collections may be submitted for approval and distribution to other compliance analysis system users. Custom and user specific content is preserved when shared compliance analysis system data collections are updated.

### BACKGROUND

Regulatory agencies routinely perform compliance audits on companies to ensure that safety, environmental protection, and other rules and regulations are being followed. Companies independently perform their own inspections for compliance with governmental regulations for various reasons such as the health and safety of their employees and communities or simply to assess the risk of being penalized by a regulatory agency. Regular inspections also allow companies to evaluate the effectiveness of company policies and training and identify areas where improvement is needed.

Inspections require familiarity with a large number of rules and regulations. Keeping abreast of changes to these rules and regulations requires a significant investment of time and resources. The quality of an inspection varies with the experience and resources of the inspector. Maintaining consistency between inspections at different times or at different sites is difficult. The actionability of individual inspection reports varies with the type, consistency, and amount of information included by the inspector. Further, missing data, format differences, and other inconsistencies in a series of inspection reports make it difficult, if not impossible, to draw meaningful conclusions about long term compliance or companywide compliance issues. It is with respect to these and other considerations that the present invention has been made.

### BRIEF SUMMARY

Embodiments of a compliance analysis system are used to evaluate and monitor compliance with a collection of rules applicable to an entity or site. The compliance analysis system uses checklists to insure consistent inspections. The compliance analysis system provides comprehensive documentation of the inspection including reference materials based on the findings of the inspection. The compliance analysis system stores the results of each inspection and allows comparison of the inspection results over time and across sites. Reports and analysis by the compliance analysis system optionally estimate discretionary penalties for violations. User created additions and modifications to the compliance analysis system data collections may be submitted for approval and distribution to other compliance analysis system users. Custom and user specific content is preserved when shared compliance analysis system data collections are updated.

The compliance analysis system includes an application server and a data server. The compliance analysis system stores data collections including, but are not limited to, one or more of the following an entity database, a location database, a finding database, a checklist database, an inspection database, a reference database, a recommendation database, a training database, and a maintenance database. The entity database stores information about the entities using the compliance analysis system such as regulatory agencies, inspectors, supervisors, employees, organizations, contractors, and subcontractors. The location database stores information about locations associated with inspections. The finding database is a collection of descriptions of hazard (i.e., violation) and/or compliance (i.e., observation) scenarios that may be noted during an inspection based on laws, regulations, standards, policies, best practices (e.g., industry best practices), and other controls. The checklist database stores different selections of findings from the finding database that the inspector should look for during an inspection. The inspection database stores details about each inspection, the results of the inspection, inspection reports, and abatements to correct issues noted during the inspection. The reference database contains reference information associated with findings that may be incorporated into a report. The recommendation database contains a description of one or more ways to correct the finding of a hazard or other violation. The training database is used to track and schedule employee training. The maintenance database is used to track the acquisition, problems, and repair of facilities and equipment and schedule maintenance.

Use of the compliance analysis system begins with the creation of information stored for later use during report generation and compliance analysis. The information creation tasks include the creation of entities and the creation of inspection checklists. Other tasks such as creating maintenance information and creating training information may also be completed at this time.

The major task of generating a report begins with creating an inspection. An inspection may be created in advance for scheduling purposes or created when an inspection has been completed. While the inspection is being performed or after completion of the inspection, the inspector creates an inspection item related to a finding on the checklist. The contents of the checklist determine the inspection items that may be entered. The inspection item is a record of what the inspector observed. The compliance analysis system also tracks the abatement status of the inspection item.

Once the inspection is complete and all inspection items have been entered, reports may be generated by the compliance analysis system. An inspection report contains the inspection items and reference items automatically attached to the inspection items by the compliance analysis system based on relationships to the findings or other criteria or selected by the inspector during creation of the report. The references and recommendations associated with a finding are entity specific.

A user can override or annotate the findings, references, recommendations, or other information to, for example, correct errors, update outdated information (e.g., a change in a regulation or company policy), or rewrite for clarity. New findings, references, recommendations, or other information may also be created. In some embodiments, the compliance analysis system automatically creates entries in an entity specific database (e.g., a local database containing only the customizations made by the user). In other embodiments, the compliance analysis system automatically submits customizations for approval and inclusion in the master database.

For an inspection item relating to a hazard, the compliance analysis system collects additional information relevant in determining a monetary penalty for the violation. The compliance analysis system has the ability to estimate the discretionary monetary penalties associated with a hazard finding. In the case of a penalizable violation, the compliance analysis system evaluates the penalties assessed for other violations to estimate a penalty amount or a range for the penalty.

The historical information collected in the compliance analysis system provides the entity with useful analysis options to evaluate compliance performance and allows supervisors and decision makers to determine where improvement is needed and where site rules and regulations are being properly followed. Comparisons may be made over time or between entities. The consistency achieved through shared data collections (e.g., findings), uniform checklists, and structured data entry that captures potentially significant information allows the compliance analysis system to perform complex analysis of compliance data. In some embodiments, the compliance analysis system automatically analyzes new findings in view of past findings and other information available to the compliance analysis system. If a trend is recognized, the compliance analysis system notifies the responsible entity. The analytical capabilities of the compliance analysis system are also beneficial to identify areas targeted the most by regulatory agencies or to evaluate the differences between the findings made by different inspectors.

### BRIEF DESCRIPTION OF THE DRAWINGS

Further features, aspects, and advantages of the invention represented by the embodiments described present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 is a block diagram of one embodiment of the compliance analysis system in a suitable operating environment;

FIG. 2 is a flowchart of one embodiment of the compliance analysis method performed by embodiments of the compliance analysis system; and

FIG. 3 is a block diagram of one embodiment of a computing device suitable for implementing embodiments of the compliance analysis system.

### DETAILED DESCRIPTION

A compliance analysis system is described herein and illustrated in the accompanying figures. The compliance analysis system is used to evaluate and monitor compliance with a collection of rules applicable to an entity or site. The compliance analysis system uses checklists to insure consistent inspections. The compliance analysis system provides comprehensive documentation of the inspection including reference materials based on the findings of the inspection. The compliance analysis system stores the results of each inspection and allows comparison of the inspection results over time and across sites. Reports and analysis by the compliance analysis system optionally estimate discretionary penalties for violations. User created additions and modifications to the compliance analysis system data collections may be submitted for approval and distribution to other compliance analysis system users. Custom and user specific content is preserved when shared compliance analysis system data collections are updated.

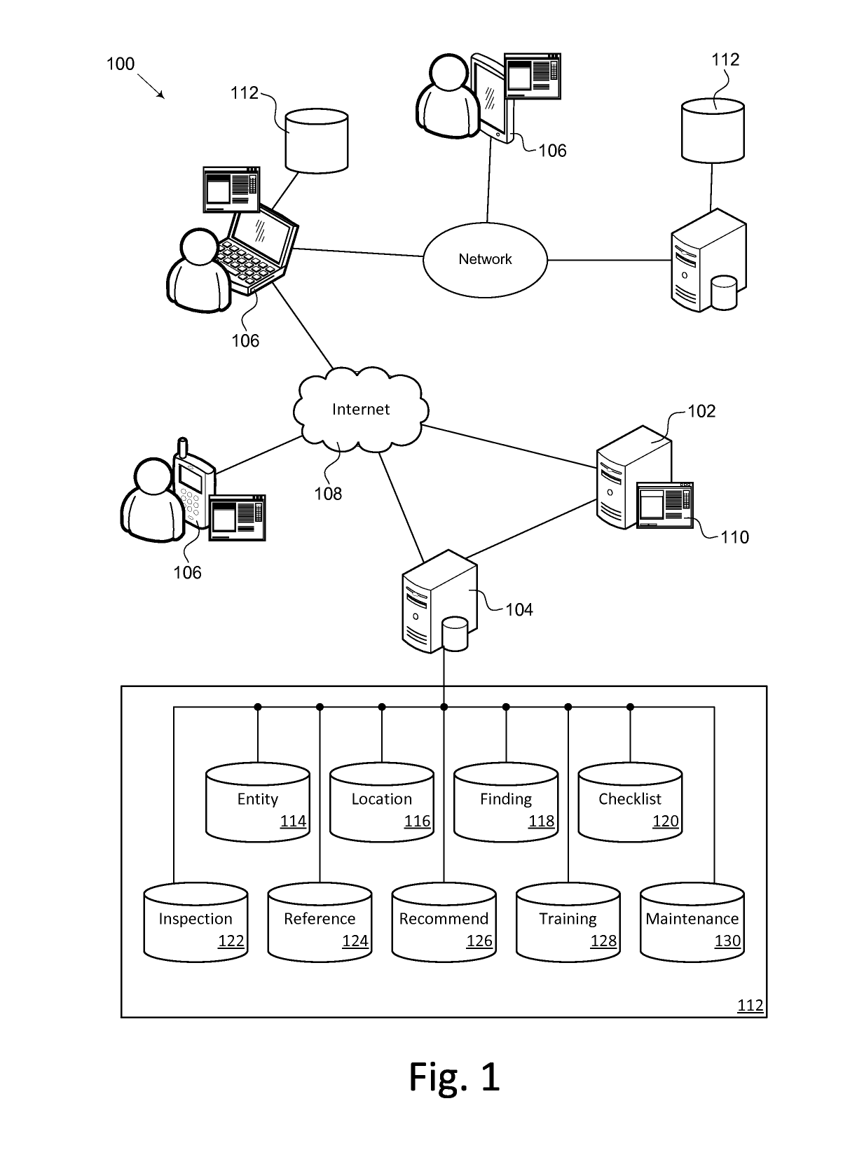

FIG. 1 is a block diagram of one embodiment of the compliance analysis system in a suitable operating environment. The compliance analysis system 100 includes an application server 102 and a data server 104. A client computing device 106 connects to the application server across via a network 108. The client computing device runs the compliance analysis application 110. In some embodiments, the compliance analysis application is executed locally by the client computing device. In other embodiments, the application server is a web application server and the client computing device accesses the compliance analysis application through a suitable web client.

The compliance analysis system stores one or more data collections 112 stored and retrieved from one or more databases accessible by the application server and/or the client computing device. For example, the compliance analysis system databases may be stored, without limitation, in a cloud based datacenter, on the application server, and locally on the client computing device. The data may be contained in a single database or distributed in multiple related databases. In some embodiments, each database includes a master database shared by all users of the compliance analysis system and a custom database available only a particular entity or entities based on permissions or physical access limitations. The data in any collection may contain internal relationships and/or be related to data in any other collection by the compliance analysis system.

The data collections utilized by the compliance analysis system include, but are not limited to, one or more of the following entity data 114, location data 116, finding data 118, checklist data 120, inspection data 122, reference data 124, recommendation data 126, training data 128, and maintenance data 130.

The entity database stores information about the entities using the compliance analysis system such as regulatory agencies, inspectors, supervisors, employees, organizations, contractors, and subcontractors. The information stored in the entity database includes, but is not limited to, contact information and relationships between the entities.

The location database stores information about locations associated with inspections. For example, location database may contain an entry for each site owned or operated by an organization, an entry for each facility at that site, and an entry for each distinct area of each facility. Each location is generally related to one or more entities such as the controlling organization and/or the person(s) responsible for compliance at that location.

The finding database is a collection of descriptions of hazard (i.e., violation) and/or compliance (i.e., observation) scenarios that may be noted during an inspection. The entries in the finding database are based on the laws, regulations, standards, policies, best practices (e.g., industry best practices), and/or any other item that a company uses to control sites, facilities, and employees. The finding database may also be used to record quality control, engineering dimensions, and similar information. For example, the compliance analysis system may include separated finding databases based on, without limitation, the federal Occupational Health and Safety Administration (OSHA) regulations (29 C.F.R §1910), the federal OSHA construction regulations (29 C.F.R §1926), California OSHA regulations, Environmental Protection Agency regulations, and Department of Transportation regulations, ergonomic best practices, and organizational policy. In various embodiments, the findings are categorized making it easier to locate the finding for a particular hazard noted during an inspection.

The checklist database stores all checklists available to the compliance analysis system. A checklist is a selection of findings from the finding database that the inspector should look for during an inspection. Once created, a checklist may be associated with an inspection or report.

The inspection database stores details about each inspection, the results of the inspection, inspection reports, and abatements to correct issues noted during the inspection.

The reference database contains reference information associated with findings that may be incorporated into a report. In various embodiments, the reference information includes the citation to and full text of the laws, regulations, standards, policies, and/or best practices on which a finding is based. In some embodiments, the reference information includes a lay description of the finding intended to simplify or better explain the finding.

The recommendation database contains a description of one or more ways to correct the finding of a hazard or other violation.

The training database stores information such as any training that is required or desired, when a particular individual was trained, how long the training remains valid (i.e., when the training must be retaken), and training schedules (i.e., course availability).

The maintenance database stores records about the acquisition, problems, and repair of facilities and equipment. Additionally, the maintenance database may be used to schedule and track routine or preventative maintenance of facilities and equipment.

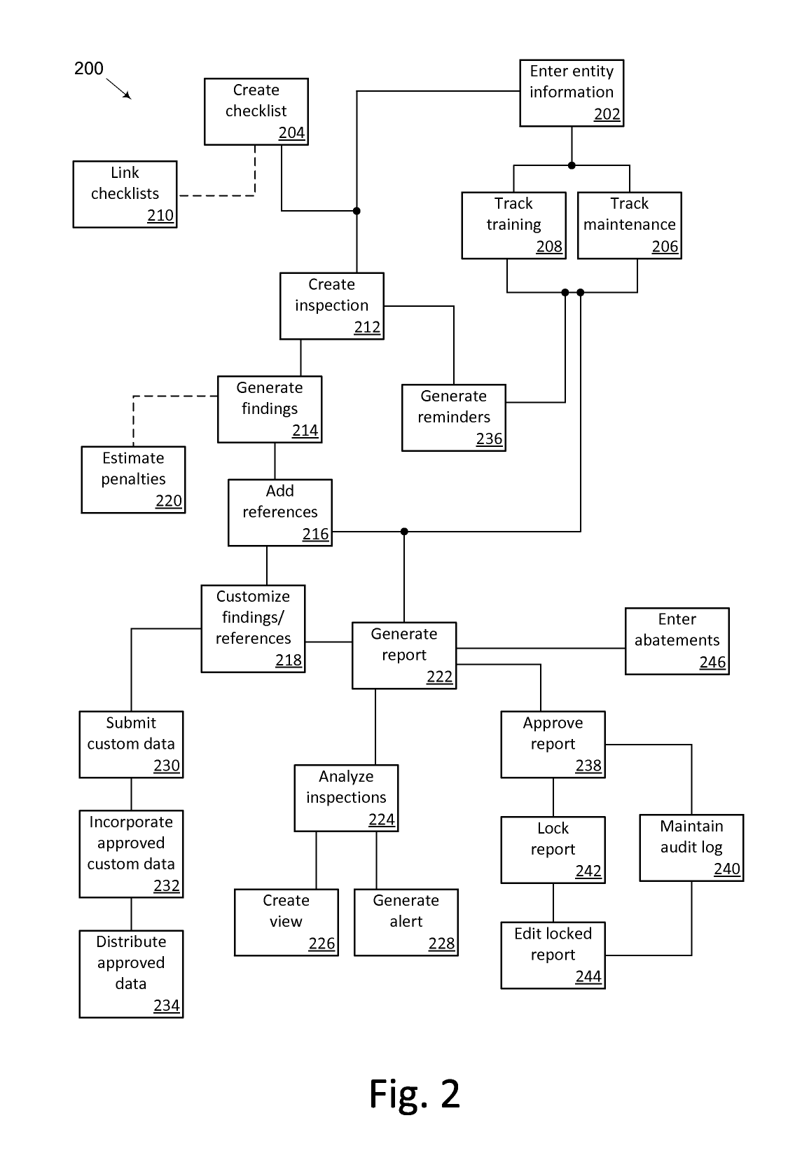

FIG. 2 is a flowchart of one embodiment of the compliance analysis method 200 performed by the compliance analysis system. The compliance analysis system begins with the creation of information stored for later use during report generation and compliance analysis. The information creation tasks include the creation of entities 202 and the creation of inspection checklists 204. Other tasks such as creating maintenance information 206 and creating training information 208 may also be completed at this time.

A checklist is created or selected for a particular audit, inspection, or investigation situation. For example, a general checklist may be created for a particular type of inspection (e.g., safety inspection or accident investigation), industry (e.g., the automotive or pharmaceutical industry), or site type (e.g., power plant or construction site). Specific checklists may be created that are customized to the needs of a particular organization, site, or facility. For example, a multi-site organization may have different checklists for individual sites. Checklists may also vary based on inspection frequency (e.g., weekly, monthly, quarterly, or yearly audits).

In various embodiments, a checklist may be built using other checklists 210. A reference to one or more existing checklists may be inserted into any checklist during checklist creation (or maintenance). For example, an organization may have a core checklist applicable to all sites. When building a checklist for any site belonging to the organization, the site specific checklist is linked to the core checklist. During execution, the compliance analysis application produces a comprehensive checklist that incorporates the inspections items from both the core checklist and the site specific checklist into a single combined checklist. Changes made to the core checklist appear in all linked checklists. This promotes inspection consistency without requiring duplicative maintenance of separate checklists. Another use includes checklists for geopolitical area (e.g., country, state, or local) specific inspection items that can be added into any checklist involving an inspection within that geopolitical area. In another example, a quarterly inspection checklist may incorporate all of the inspection items on a weekly inspection checklist by simply referencing the weekly inspection checklist.

In various embodiments, a checklist can be identified as a core checklist allowing the compliance analysis system to automatically link or suggest a link between a new checklist and the core checklist. For example, if an organizational core checklist is identified as a core checklist, the compliance analysis system may automatically include the core checklist in new checklist associated with that organization. Similarly, if the address of a site associated with a new checklist is within the boundaries of a geopolitical area for which a core checklist has been created (e.g., a site in the state of California), the compliance analysis system will offer to automatically create a link to the core checklist.

In some embodiments, the inspection items added to a checklist may be grouped based on a certain relationship. When linked checklists are combined, the inspection items from both checklists that are similarly grouped may be merged into a single group in combined checklist keeping the combined checklist organized as intended. For example, if both checklists include inspection items relating to fall hazards, the compliance analysis system places all fall hazard items into a single group in the combined checklist.

The major task of generating a report begins with creating an inspection 212. The nature of the inspection may range from an informal consultation to a formal audit where sanctions are assessed. Creating an inspection involves entering information pertaining to the inspection such as, but not limited to, the date of inspection, the inspection type, the inspector name or identifier, the checklist, the entity (e.g., organization, site, and or facility) being inspected, and the responsible personnel at the entity. The compliance analysis system simplifies inspection creation by automatically populating information using existing data based on the relationship between the data. In some embodiments, new entities are automatically created when the entity information entered for a new inspection does not exist in the entity database. An inspection may be created in advance for scheduling purposes or created when an inspection has been completed.

While the inspection is being performed or after completion of the inspection, the inspector creates an inspection item related to a finding 214. The inspector may access the application server from a client device to view the inspection checklist and enter findings directly into the compliance analysis system while performing the inspection. Alternatively, an offline version of the inspection checklist can be downloaded to the client device and used during the inspection to record the findings. Following the inspection, the findings are synchronized with the compliance analysis system. Finally, the inspection checklist may be printed for use during an inspection and the findings entered into the compliance analysis system after the inspection using notes taken during the inspection.

The contents of the checklist determine the inspection items that may be entered. The inspection item is a record of what the inspector observed. In some embodiments, details relating to an inspection item, such as the facility or work area where the inspection item occurred and the foreman and/or subcontractor responsible for the location where the inspection item occurred are automatically populated by the compliance analysis system based on relationships as appropriate. Details may also be selected from existing data in the compliance analysis system or data added during creation of the inspection item. Documentary evidence (e.g., photographs) of the inspection item may be attached to each observation item and stored by the compliance analysis system.

The compliance analysis system also tracks the abatement status of the inspection item. The abatement status indicates whether correction of a hazard or violation is needed, the time frame for making the correction, and when the correction is completed. Examples of abatement status indicators used in the compliance analysis system include, but are not limited to, “open” (i.e., uncorrected, not severe), “open asap” (i.e., uncorrected, immediate correction required), “open stop” (i.e., uncorrected, work cannot continue until corrected), “closed otsc” (i.e., corrected, on the spot correction), and “closed” (i.e., corrected). The compliance analysis system may use the abatement status indicator to determine whether a field is required in the inspection item. In various embodiments, the compliance analysis system automatically calculates the deadline to correct the hazard based on rules associated with the finding. Abatement specific information such as the date the hazard was corrected, the supervisor overseeing the correction, and documentary evidence of abatement (e.g., photographs of the correction or scans of repair tickets) may be entered/attached when correction of a hazard occurs 246.

Fields in an inspection that do not contain data are not included in the inspection report. Similarly, findings on the checklist without any associated inspection items may be omitted from the report. Alternatively, the report may list such findings in the report with an indication that violations were observed. As noted above, inspection items may also show compliance with a finding (i.e., an observation, as opposed to a hazard). This allows the report to indicate the ratio of compliant behaviors to hazards. For example, a report stating that five fall protection hazards were observed does not tell the reader whether this is a significant problem. By also reporting that 95 ladders were observed being used correctly, it becomes clear that the hazards were only a small part of the overall ladder usage. Similarly, while five fall protection hazards may seem like a small number, reporting that zero ladders were observed being used correctly alerts the reader that ladders are being used incorrectly 100% allowing the reader to determine that ladder safety training may be warranted.

References and recommendations are automatically attached to the inspection items by the compliance analysis system based on relationships to the findings or other criteria or selected by the inspector during creation of the report 216. In various embodiments, the compliance analysis system links references and recommendations associated with the finding to the inspection item. Some or all of the references and recommendations associated with a finding may be entity specific. For example, a fire hazard finding may cite a reference to the OSHA regulation. If the entity has access to the National Fire Protection Association (NFPA) reference database, the finding may also generate a reference to the auxiliary NFPA regulation on which the OSHA regulation is based. In addition, the finding may also generate references to related organizational policies from the organization's custom databases or local fire protection regulations, if available.

A user can override or annotate the findings, references, recommendations, or other information to, for example, correct errors, update outdated information (e.g., a change in a regulation or company policy), or rewrite for clarity 218. New findings, references, recommendations, or other information may also be created. In some embodiments, the compliance analysis system automatically creates entries in an entity specific database (e.g., a local database containing only the customizations made by the user). In other embodiments, the compliance analysis system automatically submits customizations for approval and inclusion in the master database. In some embodiments, the user is given the opportunity to decide whether to submit a customization for approval.

For an inspection item relating to a hazard, the compliance analysis system collects additional information such as the severity of the hazard (e.g., warning, non-serious, serious, or willful), the chance of accident associated with the hazard (e.g., low, medium, or high), the severity of injury (e.g., low, medium, or high), the number of previous hazards found and/or penalties assessed, and the size of the entity. In various embodiments, the compliance analysis system analyzes prior inspections to determine the number of previous hazard findings and/or assessed penalties.

The compliance analysis system has the ability to estimate the monetary penalties associated with a hazard finding 220. The guidelines for regulatory monetary penalties for a violation often give the regulatory agency inspector or local field office supervisor discretion to adjust the amount based on other factors associated with the inspection (e.g., cooperating or hindering the investigation). In the case of a penalizable violation, the compliance analysis system evaluates the penalties assessed for other violations to estimate a penalty amount or a range for the penalty. In a basic embodiment, the penalty estimate is based on an average of prior penalties for a particular finding. In some embodiments, the compliance analysis system only uses amounts from violations having similar characteristics (e.g., the same severity level) in estimating the penalty amount. In other embodiments, the compliance analysis system applies different weights to the penalties used in the estimate based on similarity of the situation. For example, greater weight may be given to recently issued penalties, penalties issued by the local office, penalties assessed against other sites belonging to the organization being inspected, the number of past findings for the same hazard at the site or across the organization, and the severity of the violation. The estimated amount of the penalty is shown in the report.

Once the inspection is complete and all inspection items have been entered, reports may be generated 222 by the compliance analysis system. Different types of reports may be generated by the compliance analysis system. An inspection report provides full details of the inspection. Embodiments of the inspection report may include the category of the finding, the finding type (e.g., hazard or observation), the finding description, any associated references, and any associated recommendations, and, optionally, any estimated penalty amounts associated with hazard findings. Alternatively, the compliance analysis system generates a findings report that lists only recommendations and the person responsible for correcting the hazard. The compliance analysis system may generate reports in draft or final form. Reports may be generated for a single inspection, multiple selected inspections, or covering inspections within a selected period.

The compliance analysis system allows the format of reports to be customized for a particular entity. A report may include regions that default to a standard format unless custom information is provided. Examples of customizations include headers/footers, phone numbers, graphics/pictures, etc. The customizations are associated with the entity. When the compliance analysis system generates a report for an entity with associated customizations, the customizations are used in place of the default report details.

The inspection database also provides storage for informal inspection notes. Informal inspection notes do not appear in the inspection report, but are available for review by users of the compliance analysis system with appropriate permissions. Other items such as a cover letter for an inspection report can be generated and stored with the findings by the compliance analysis system.

Virtually any of the data available to the compliance analysis system can be searched or sorted (e.g., alphabetically or by date). The compliance analysis system allows items such as inspections reports to be located any of the associated data. For example, an inspection report can be found under the associated organization, site, facility, responsible supervisor, inspector, checklist, and/or findings.

The historical information collected in the compliance analysis system provides the entity with useful analysis options to evaluate compliance performance. This allows supervisors and decision makers to determine where improvement is needed and where site rules and regulations are being properly followed. Comparisons may be made over time or between entities. The compliance analysis system can perform detailed analysis on the historical information 224 to create a comprehensive view 226 of compliance achievements and failures. The views provided by the compliance analysis system include tables, charts, and graphs. Using the compliance views, those responsible for compliance may quickly assess the most significant compliance issues and evaluate the impact of policy changes relating to compliance issues. By comparing the findings across multiple sites, the compliance analysis system shows what compliance issues are most significant for the entire company. The compliance views allow assessment of the initiatives to address compliance issues (e.g., policies changes or training) in a way that is meaningful and actionable by entities.

The consistency achieved through shared data collections (e.g., findings), uniform checklists, and structured data entry that captures potentially significant information allows the compliance analysis system to perform complex analysis of compliance data. In some embodiments, the compliance analysis system automatically analyzes new findings in view of past findings and other information available to the compliance analysis system. If a trend is recognized, the compliance analysis system notifies the responsible entity 228. For example, an increase in findings of fall hazards on the two most recent inspection reports would be recognizable trend. The compliance analysis system can then analyze additional data for possible reasons for the increase. For example, upon determining that the supervisor on the last two reports is different from the supervisor on the earlier reports, the compliance analysis system could notify the supervisor's superior of the trend and a possible cause allowing corrective action (e.g., training) to be taken. The compliance analysis system can analyze trends in view of other information. For example, an increase or decrease in compliance might be found to coincide with the entry of a new company policy into the rules database allowing the compliance analysis system to notify the entity of the positive or negative impact potentially resulting from the policy introduction. Such a relationship could easily go unnoticed where causation between the finding and the policy was not expected.

The analytical capabilities of the compliance analysis system are also beneficial to identify areas targeted the most by regulatory agencies or to evaluate the differences between the findings made by different inspectors (e.g., between different individual inspectors or between private inspectors and regulatory agency inspectors).

As previously discussed, the compliance analysis system provides users with the ability to create add or modify findings, references, and other data. In various embodiments, the compliance analysis system does not actually add a new or modified finding or reference to the master database. Instead, the compliance analysis system places new or modified finding or references into a temporary storage and notifies an administrator of the compliance analysis system that a new or modified finding or reference is available as a proposed entry for review 230. If the compliance analysis system administrator approves, the compliance analysis system incorporates the proposed entry into the corresponding database 232. If rejected, the proposed entry is not added to a master database. The compliance analysis system administrator may edit the proposed entry prior to approval. In such case, the compliance analysis system adds the edited version of the proposed entry to the corresponding master database and updates any item using the proposed entry to the edited version. In some embodiments, the compliance analysis system notifies the creator when the proposed entry is approved, edited, or rejected. Various embodiments of the compliance analysis system require approval of a proposed entry before a report including the proposed entry can be finalized.

The approval system works on both a local scale and a global scale. For instance, an organization may have an in-house compliance analysis system administrator who approves regulations, policies, and other references for use within the organization. The proposed entries may also be shared with the provider of one or more of the master databases used with the compliance analysis system where the proposed addition can be adopted for global use and ultimately distributed to other entities using the compliance analysis system 234. This allows for collaborative mechanism for building, maintaining, and sharing information that adds to the utility of the compliance analysis system.

In some embodiments, each entity maintains its own version the compliance analysis system databases. If the master databases are updated, each entity can elect to merge the changes into their versions of the databases. In other embodiments, each entity maintains a copy of the master database and an auxiliary database containing entity specific customizations. The copy of master database is overwritten with the latest version when an entity elects to update the master database. In some embodiments, each entity shares a master database but maintains an auxiliary database containing entity specific customizations allowing all entities to always access the most current version of the master database.

In order to maintain historical data consistency, a master database may be versioned when significant changes occur. This allows the findings, references, and other data that applied at the time of an inspection or report to be available when viewing past reports. Alternatively, items in a master database may contain revision dates that are compared to the date of the inspection by the compliance analysis system to determine applicability. In either instance, the compliance analysis system is able to generate a report or perform analysis with different revisions c for purposes of comparison. With versioned databases, the report or analysis would be run against multiple versions of the same database and the results aggregated. In databases containing items with revision dates, the applicable date filtering is turned off allowing all revisions to be returned. Where historical data consistency is not required, reports and analysis always return the latest revisions.

The compliance analysis system provides reminders to one or more entities associated at selected intervals in advance of a tracked or scheduled event 236. For example, the compliance analysis system can provide advance notice of scheduled maintenance to the supervisor responsible allowing the supervisor to make sure the necessary supplies and personal are available. For training events, the compliance analysis system can notify the associated supervisor that an employee is due for training so the supervisor can make appropriate work schedules. The compliance analysis system can also track the number of personnel whose training is about to expire and project dates when training should be held to maximize training efficiency.

As with maintenance and training, the compliance analysis system tracks the status of inspections. In the case of scheduled inspections, the compliance analysis system provides reminders to the inspector about the upcoming inspection. The compliance analysis system optionally allows notifications to be provided to additional associated entities (e.g., the organization or site being audited) depending upon whether or not the inspection is to be unannounced.

The compliance analysis system tracks the status from creation on an inspection to the delivery of an inspection report to the appropriate entity. An inspection that has been scheduled but not performed is noted as pending. An inspection that has been started but not completed is noted as incomplete. Once an inspection is finished, the inspection is noted as complete and the associated report is noted as awaiting findings. An inspection report that has been started but not completed and delivered is noted as a draft. Once delivered to the proper entity, the inspection report is noted as final. In some embodiments, the compliance analysis system requires approval of a draft report by a user with sufficient privileges before the report is made final and/or delivered 238. Additional status identifiers such as “awaiting approval” and “approved” may be used to identify complete but unapproved reports and approved reports that have not been delivered. The compliance analysis system optionally stores the date and time that a report was approved and the identity of the user approving the report in a secure audit log 240.

In various embodiments, the compliance analysis system restricts editing of some or all of report that has approved and/or final status. When a report is marked as approved or final, the compliance analysis system locks the report 242. Editing a locked report may only be performed by a user with sufficient privileges. Any time a locked report is edited 244, the compliance analysis system generates an audit record that identifies when the changes were made, what information was change (e.g., before and after contents), and the user making the changes. The compliance analysis system optionally collects additional information from the user such as the reason for making the change and makes this additional information part of the audit record. Audit records are stored in a secure audit log to provide accountability. In various embodiments, certain portions of the report remain unlocked and may be exempted from audit logging. For example, portions of the report relating to abatement would generally be completed or updated after the report was generated.

Another aspect of security is historical data maintenance. While information is readily added to the compliance analysis system, deletion of information is restricted. In various embodiments, the compliance analysis system marks data as inactive and filters it from future selection views rather than deleting information. This prevents the deletion of information useful when performing historical analysis or needed to update or regenerate reports. Some embodiments of the compliance analysis system allow permanent deletion of information if the compliance analysis system determines that the information to be deleted has no existing relationships to other data. In some cases, only significant relationships preclude the deletion of the information to avoid the need to manually disassociate data lacking historical significance from numerous other pieces of information. For example, an employee associated with an organization, site, facility, and work area but never associated with an inspection report could be deleted without breaking the link between each associated location.

Although described in terms of assessing regulatory or policy compliance, the compliance analysis system inspections may be used as a documentation tool for site audits, site procedures, corrective actions, and required programs and for other purposes where consistent, on-going monitoring is desired or required, such as quality assurance and policy assessment.

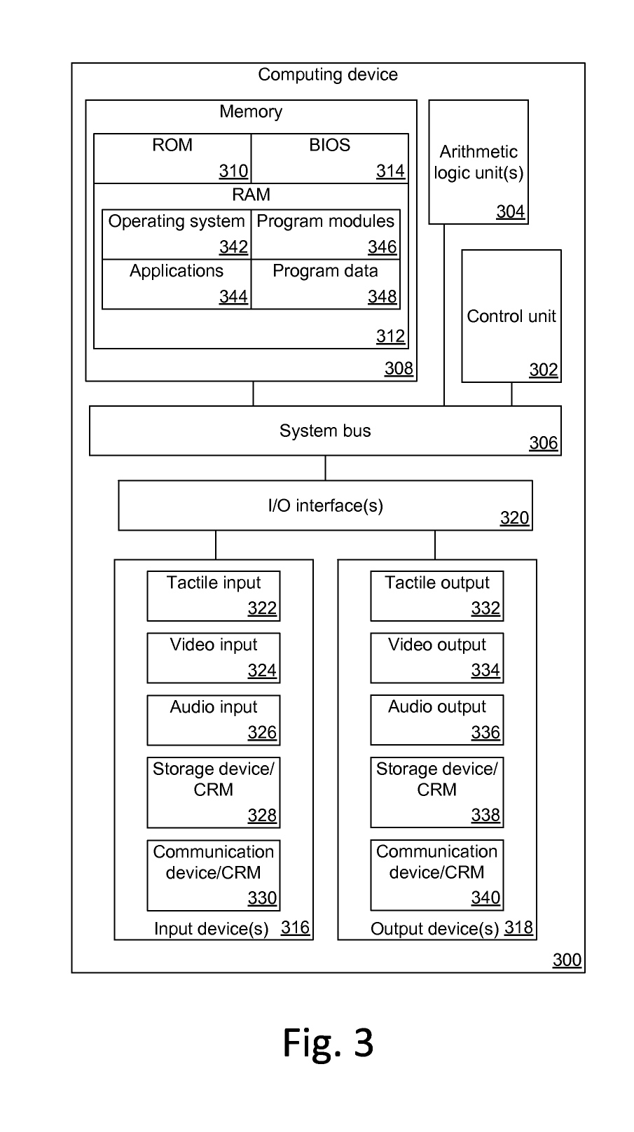

FIG. 3 illustrates an exemplary computing device that can be used to implement aspects of the present invention. Examples of suitable implementations of the computing device 300 include, but are not limited to, desktop computers, laptop computers, tablet computers, netbooks, smart phones, media players, personal digital assistants, or other devices configured to process digital instructions. The illustrated computing device is suitable to execute the operating system, application programs/services, and software modules (including the software engines) described herein. The computing device also serves as an example of programmable electronics, which may include one or more such computing devices, and when multiple computing devices are included, such computing devices can be coupled together with a suitable data communication network to collectively perform the various functions, methods, or operations disclosed herein.

The computing device 300 includes, in some embodiments, at least one general purpose or application specific control unit 302, such as a central processing unit (CPU) or other controller. Examples of suitable control units include, but are not limited to, microprocessors, application specific integrated circuits, field programmable gate arrays, and programmable logic devices. In various embodiments, the computing device includes one or more arithmetic logic units 304 that perform computations and logical functions. In some embodiments, at least one arithmetic logic unit is part of the control unit. In some embodiments, one or more arithmetic logic units are part of other components (e.g., graphics adapters).

In illustrated embodiment, the computing device 300 includes a system bus 306. The system bus 306 includes one or more intra-system communication channels, as required by the computing device, coupling various system components to the control unit 302. Examples of suitable intra-system communication channels include, but are not limited to, memory buses, memory controllers, peripheral buses, and local buses implemented using any of a variety of bus architectures.

The illustrated embodiment of the computing device includes a memory 308. In various embodiments, the memory 308 includes read only memory (ROM) 310 and/or random access memory (RAM) 312. In some embodiments, a basic input/output system (BIOS) 314 contains the basic instructions to operate the computing device 300 before an operating system is loaded. The BIOS 312 is typically stored in the read only memory 310.

The computing device optionally includes one or more input devices 316 and/or one or more output devices 318 typically connected to the control unit 302 through one or more input/output (I/O) interfaces 320 coupled to the system bus 306. The input devices 316 allow the computing device 300 to receive information, instructions, and/or data from a user or other external source. The input devices 316 and/or the output devices 318 are connected to the computing device 300 using any number of suitable I/O interfaces types including, but not limited to, parallel ports, serial ports, universal serial bus (USB) ports, graphics adapters, and network adapters. In addition to wired connections, optical and radio frequency I/O interface types including, but not limited to, infrared ports, Bluetooth® wireless technology, Wi-Fi (e.g., 802.11a/b/g/n), cellular (e.g., 3G, 4G, 4GLTE) allow communications with the input devices 316 and/or the output devices 318 in some embodiments.

The input devices 316 optionally include one or more of a tactile input device 322 (e.g., a keyboard, mouse, touch pad, touch screen), a video input device 324 (e.g., a camera) an audio input device 326 (e.g., a microphone), a storage device 328 (e.g., a hard disk drive), and a communication device 330 (e.g., a network adapter or modem). Other input devices include, but are not limited to, sensors (e.g., an accelerometer). The output devices 318 allow the computing device 300 to send information, instructions, and/or data to a user or other external source. The output devices 318 optionally include one or more of a tactile output device 332 (e.g., haptic feedback device), a video output device 334 (e.g., a video display), an audio output device 336 (e.g., a speaker), a storage device 338 (e.g., a hard disk drive), and a communication device 340 (e.g., a network adapter or modem). Other output devices include, but are not limited to, printers.

The computing device 300 typically includes at least some form of computer readable media. Computer readable media includes any available media accessible by the computing device 300. By way of example, computer readable media include computer readable storage media and computer readable communication media. Accordingly, some embodiments of the computing device 300 include a storage device 314 containing or accepting computer readable storage media allowing retrieval and substantially non-volatile storage of computer readable instructions (including application programs and program modules), data structures, and other data for the computing device 300. In various embodiments, the storage device 314 contains or accepts magnetic, optical, or solid state computer readable media. Examples of suitable computer readable media includes magnetic tape drives, floppy disk drives, hard disk drives, solid state drives, compact disc (CD) drives, digital video/versatile disc (DVD) drives, high definition (HD) disc memories, BluRay disc drives, and flash memory cards. Some embodiments of the storage device/computer readable media are removable while other embodiments are not removable. Some embodiments include non-transitory media. Additionally, in some embodiments, the storage device includes local storage or cloud-based storage.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 300.

A number of program modules are optionally stored using memory 308 and/or storage device/computer readable media 328, 338, including an operating system 342, one or more application programs 344, other program modules 346 (such as the software engines described herein), and program data 348. Examples of suitable operating systems include, but are not limited to, Microsoft® Windows®, Google Chrome®, Mac OS®, Google Android®, and Linux. Other examples can include Microsoft, Google, or Apple operating systems, or any other suitable operating system used in tablet computing devices.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method of monitoring and analyzing compliance with a set of rules, the method comprising the acts of:
creating a checklist of findings;
recording an inspection items associated with one of the findings on the checklist;
selecting a supporting reference based on the finding, the supporting reference being at least one of a rule and a recommendation;
displaying a report containing the finding with the supporting reference.

2. The method of claim 1 further comprising the acts of:
compiling a master collection of rules associated with a master collection of findings; and
compiling a master collection of recommendations associated with a master collection of findings.

3. The method of claim 1 further comprising the acts of:
receiving a new rule entered into a remote collection of rules;
accepting the new rule as part of the master collection of rules.

4. The method of claim 1 further comprising the acts of:
providing a notification that the master collection of rules has been updated; and
selectively updating other remote collections of rules with the master collection of rules.

5. The method of claim 1 further comprising the acts of:
providing a notification that the master collection of rules has been updated; and
selectively updating other remote collections of rules with the new rule upon request.

6. The method of claim 1 characterized in that the collection of rules is selected from a collection of statutory rules, a collection of regulatory rules, or a collection of organizational policies.

7. The method of claim 1 further comprising the acts of:
determining that the finding is associated with a penalizable violation of the rule;
estimating a monetary penalty associated with the penalizable violation.

8. The method of claim 1 further comprising the act of:
tracking training required to comply with a rule;
generating an alert when an employee is due for training.

9. A system for monitoring and analyzing compliance with a set of rules, the system comprising a computing device executing a compliance analysis application operable to:
maintain a collection of findings corresponding to violations of a set of rules;
maintain a collection of references corresponding to the set of rules;
create a checklist containing selected findings;
create an inspection item corresponding to one of the findings from the checklist;
associate a reference from the collection of references with the inspection item; and
produce a report containing the inspection item supported by the reference.

10. The system of claim 9 further operable to create a relationship between each reference in the collection of references with a finding from the collection of findings.

11. The system of claim 9 further operable to:
customize the finding; and
submit the customized finding for approval.

12. The system of claim 9 further operable to associate the checklist with an inspection.

13. The system of claim 12 further operable to maintain a collection of entity information pertaining to entities associated with an inspection.

14. The system of claim 12 further operable to keep track of a hazard associated with a finding.

15. The system of claim 14 further operable to identify that the hazard has been abated.

16. The system of claim 14 further operable to identify that the hazard remains uncorrected.

17. A computer readable medium containing computer executable instructions which, when executed by a computer, perform a method for evaluating compliance with a set of rules, the method comprising the acts of:
creating a record associated with a site to be inspected;
creating a list of findings to be checked during an inspection;
creating an inspection record for the inspection;
associating the site with the inspection record;
associating the list with inspection record; and
recording an inspection item for a finding on the list corresponding to a hazard.

18. The computer readable medium of claim 17 characterized in that the method further comprises the acts:
collecting information from a plurality of inspections performed at the site at different times; and
analyzing the information from the plurality of inspections to identify recurring findings.

19. The computer readable medium of claim 17 characterized in that the method further comprises the acts:
collecting information from a plurality of inspections performed at different sites operated by an organization; and
analyzing the information from the plurality of inspections to identify findings prevalent at multiple sites.

20. The computer readable medium of claim 17 characterized in that the method further comprises the acts:
recording an inspection item for a finding on the list corresponding to an observation of compliance;
evaluating the inspection items for corresponding findings to determine the relationship between the number of hazards and the number of observations of compliance.
